(19) United States
(12) Patent Application Publication
(10) Pub. No.: US 2023/0407160 A1
(43) Pub. Date: Dec. 21, 2023

(54) SEPIOLITE CONTAINING DRILLING FLUID COMPOSITIONS AND METHODS OF USING THE SAME

(71) Applicants: CARL THAEMLITZ, Tomball, TX (US); GREGORY SZUTIAK, Calgary (CA)

(72) Inventors: CARL THAEMLITZ, Tomball, TX (US); GREGORY SZUTIAK, Calgary (CA)

(21) Appl. No.: 18/210,064

(22) Filed: Jun. 14, 2023

Related U.S. Application Data
(60) Provisional application No. 63/352,417, filed on Jun. 15, 2022.

(51) Int. Cl. C09K 8/16; C09K 8/14; E21B 21/00

(52) U.S. Cl. CPC C09K 8/16; C09K 8/145; E21B 21/00

(57) ABSTRACT

A drilling mud containing sepiolite and potassium carbonate and which is free of potassium chloride is useful in high temperature reservoirs, such as geothermal wells.

### CROSS-REFERENCE TO RELATED APPLICATION

This application claims the benefit of U.S. Provisional Patent Application No. 63/352,417, filed Jun. 15, 2022, which is incorporated by reference herein in its entirety.

### BACKGROUND

The past fifty years has seen an increase in the recovery of geothermal energy from hard rock formations such as granite, granodiorite, quartzite, greywacke, basalt, rhyolite and volcanic tuff which, typically, are 3,000 to 5,000 meters below the earth's surface. Compared to the sedimentary formations of most oil and gas reservoirs, geothermal formations are characterized by higher temperatures (generally hotter than 500° F.) and greater hardness (typically 240+ MPa compressive strength) than those sedimentary formations. These conditions make the drilling of geothermal formations far more difficult, costly and time consuming. Further, drilling of geothermal reservoirs is typically adversely affected by production of corrosive fluids, such as hydrogen sulfide and carbon dioxide, as well as the frequent loss of circulation of the drilling mud in the subsurface formation caused most often by lower formation pressures within the reservoir.

Conventional drilling fluids or muds for most oil and gas reservoirs do not maintain functionality at temperatures necessary for high temperature geothermal well drilling applications. Sepiolite is a phyllosilicate clay mineral characterized by an aspect ratio between 30 and 200. It consists of needle-like fibers which impart fluid viscosity to the drilling fluid through their fibrous interactions. Sepiolite is more resistant to structural changes at high temperatures than most clay minerals and thus has proven to be an acceptable viscosifying agent in aqueous-based fluids used in geothermal drilling.

Geothermal drilling fluids containing sepiolite also often contain a stabilizing amount of potassium. Potassium has been shown to inhibit rearrangement of the sepiolite structure at temperatures above 932° F. Typically, the source of potassium ions in the drilling fluid has been potassium chloride. Chloride anions at the concentrations needed in geothermal drilling fluids, however, are usually undesirable because they cause premature gelation of the drilling fluid at low shear rates as well as excessive gelation during times of no circulation within the reservoir and when the drilling pipe is removed from the wellbore. In addition, premature gelation of the drilling fluid relative to the presence of chloride anions causes wellbore instability due to high surge and swab pressures required for breaking the gel strength of the mud. It is commonly understood that effective removal of drilled cuttings from the geothermal reservoir are negatively impacted by the presence of chloride anions in the mud when used at temperatures at which geothermal wells are drilled.

Alternative drilling fluids suitable for use at the elevated temperatures of geothermal reservoirs are therefore desired. The present invention meets this need.

### SUMMARY OF THE INVENTION

The invention is a drilling mud for high temperature applications comprising water, sepiolite clay, potassium carbonate and other materials. The use of potassium carbonate prevents or controls gelation of the drilling mud under conditions experienced in high temperature drilling operations.

### DRAWINGS

FIG. 1 shows rheological profiles at high temperature and high pressure conditions of a sepiolite containing drilling fluid having potassium carbonate as well as potassium chloride.

FIG. 2 shows rheological profiles at ambient pressure and low temperature conditions of a sepiolite containing drilling fluid having potassium carbonate as well as potassium chloride.

### DETAILED DESCRIPTION OF THE PREFERRED EMBODIMENTS

Certain terms are used herein and in the appended claims to refer to particular components. As one skilled in the art will appreciate, different persons may refer to a component by different names. This document does not intend to distinguish between components that differ in name but not function.

Also, the terms “including” and “comprising” are used herein and in the appended claims in an open-ended fashion, and thus should be interpreted to mean “including, but not limited to . . . .”

The suffix “(s)” as used herein is intended to include both the singular and the plural of the term that it modifies, thereby including at least one of that term. Reference herein and in the appended claims to components and aspects in a singular tense does not necessarily limit the present disclosure or appended claims to only one such component or aspect, but should be interpreted generally to mean one or more, as may be suitable and desirable in each particular instance. The use of the terms “a” and “an” and “the” and similar variants in the context of describing the embodiments (especially in the context of the following claims) are to be construed to cover both the singular and the plural, unless otherwise indicated herein or clearly contradicted by context.

All ranges disclosed herein are inclusive of the endpoints. A numerical range having a lower endpoint and an upper endpoint shall further encompass any number and any range falling within the lower endpoint and the upper endpoint. For example, every range of values (in the form “from a to b” or “from about a to about b” or “from about a to b” and any similar expressions, where “a” and “b” represent numerical values of degree or measurement is to be understood to set forth every number and range encompassed within the broader range of values and inclusive of the endpoints.

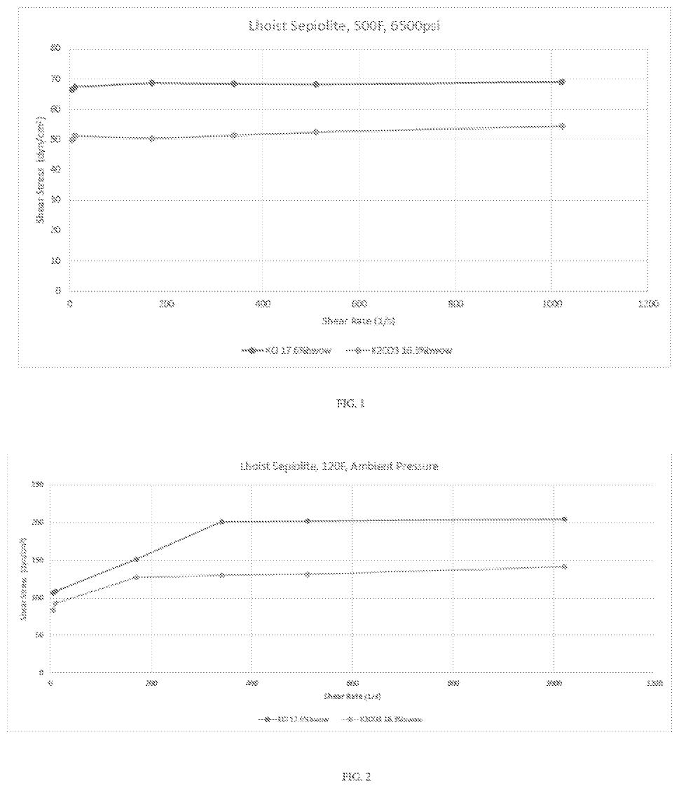

Referring now to FIGS. 1 and 2, the drilling mud disclosed herein is a water-based mud and may contain a clay, such as sepiolite, having a wide aspect ratio. The drilling mud may be used effectively in the drilling of wells having a broad downhole temperature range. In an embodiment, the drilling mud may be used in the drilling of deep wells exhibiting extreme temperatures and pressures. For example, the drilling mud may be used as a drilling fluid for geothermal wells through formations at temperatures from 500° F. to over 1200° F. The drilling mud may further be used for subterranean wellbore construction operations at temperatures lower than those usually ascribed to geothermal parameters. For example, the drilling mud may be used in the drilling of traditional petroleum oil and gas wells, such as those having a bottomhole temperature from 150° F. to 600° F.

The pH of the drilling mud used for traditional oil and gas wells is typically alkaline and generally is higher than an aqueous-based drilling mud containing potassium chloride. Typically, the pH of the drilling mud is from about 4 to about, typically, from about 7.5 to about 12.5, more typically from about 9.5 to about 12.2. In addition to providing the requisite alkalinity for the rheological profile of the drilling mud, the alkaline conditions of the drilling mud are also instrumental in minimizing corrosion within the reservoir. Further, the alkaline condition of the drilling mud allows for appreciable buffering of formation-sourced acid gases.

The drilling mud disclosed herein may be (and generally is) free of chloride ions. It may, however, contain potassium in some form. A suitable source of potassium in the drilling mud is potassium carbonate, though other sources of potassium, such as potassium hydroxide, may also be used. In an embodiment, the drilling mud may contain a significant excess of a soluble carbonate salt, such as potassium carbonate, for the carbonate to function as a buffering base. The amount of potassium carbonate should be sufficient to effectively enable neutralization by the buffering base carbonate anion of naturally occurring acid gases, such as hydrogen sulfide and carbon dioxide, which are often encountered in the geothermal reservoir during the drilling process. Such gases, if not neutralized, can result in the corrosion of downhole equipment, including drill string hardware and tool joints. Safety to the operator is also enhanced by the prevention of acid gas release to the surface.

In an embodiment, the soluble carbonate-based, carbonate-buffered, water-based sepiolite drilling mud does not demonstrate any unfavorable sensitivity in performance due to the inclusion of the carbonate in the mud. This is counter-intuitive as to what would be expected. In traditional drilling muds, carbonates are known to contaminate the mud. Carbonates may be formed when carbon dioxide (a common constituted in natural gas and present in most formations) dissolves in water to form carbonic acid. The carbonic acid in turn lowers the pH of the fluid, which causes hydroxyl ions in the mud to revert to bicarbonates and carbonate ions. Carbonate contamination is known to adversely affect traditional bentonite-containing drilling fluids by elevating the gel strength of the mud and thus compromise the performance of the drilling mud. When used, however, in sepiolite-containing muds, the addition of potassium carbonate does not adversely affect gel strength. In fact, the rheological profile of a drilling mud of the present disclosure improves at high temperatures when the mud contains potassium carbonate in place of potassium chloride.

The carbonate containing mud defined herein is highly stable at elevated downhole conditions due, in part, to high alkalinity and its unusual tolerance for carbonate contamination. The rheological properties and shear thinning of the drilling mud enables cuttings to be lifted from the hole and enables the drilling mud to avoid or overcome irreversible extreme gel formation resulting from the mud remaining uncirculated in the hole for extended periods. In some instances, the drilling mud of the present disclosure is able to return to its original viscous and rheological state once the drilling mud is removed from the high temperature environment of the well.

Along with improving the rheological properties of the traditional mud, the lack of chlorides, such as potassium chloride, in the drilling mud renders the fluid more compatible with the environment. Because the mud is free of potentially hazardous chloride ions, it is easier to dispose of.

Further, the mud offers an alternative to potassium chloride containing muds as the availability of potassium chloride becomes limited due to embargos and supply chain disruptions.

The following examples are illustrative of some of the embodiments of the disclosure. Other embodiments within the scope of the claims herein will be apparent to one skilled in the art from consideration of the description set forth herein. It is intended that the specification, together with the examples, be considered exemplary only, with the scope and spirit of the disclosure being indicated by the claims which follow. All percentages set forth in the Examples are given in terms of weight units except as may otherwise be indicated.

### Example 1

About 350 grains (“g”) of tap water was blended with 20 g of sepiolite clay (from Lhoist North America) and potassium carbonate or potassium chloride. The amount of potassium salt in the fluid was calculated on a molar basis such that the fluids contained an equivalent amount of the potassium salt—the amount of potassium chloride being 17.6 percent by weight of water and the amount of potassium carbonate being 16.3 percent based on weight of water (“bwow”). The shear stress of the drilling mud at varying shear rates was determined using a standard oilfield viscometer such as FANN® viscometer operated at a constant pressure of 6,500 pounds per square inch (“psi”) at 500° F. and the results are shown in FIG. 1. The shear stress of the drilling mud at varying shear rates was determined in a like manner at ambient pressure at 120° F. and the results are shown in FIG. 2 and illustrate the viscosity of fluids containing potassium carbonate are similar to those fluids containing potassium chloride. The figures establish that the muds free of chlorides and having high levels of carbonates exhibit a stable rheological profile and are suitable for drilling of geothermal wells at elevated temperatures. The soluble carbonates are believed to serve as an alkalinity buffer and, when coupled with the potassium cations, provide stability to the sepiolite containing fluid as exhibited by the stable rheological profile. The pH of the fluid is 12.0.

The methods that may be described above or claimed herein and any other methods which may fall within the scope of the appended claims can be performed in any desired suitable order and are not necessarily limited to any sequence described herein or as may be listed in the appended claims. Further, the methods of the present disclosure do not necessarily require use of the particular embodiments shown and described herein, but are equally applicable with any other suitable structure, form and configuration of components.

While exemplary embodiments of the disclosure have been shown and described, many variations, modifications and/or changes of the system, apparatus and methods of the present disclosure, such as in the components, details of construction and operation, arrangement of parts and/or methods of use, are possible, contemplated by the patent applicant(s), within the scope of the appended claims, and may be made and used by one of ordinary skill in the art without departing from the spirit or teachings of the disclosure and scope of the appended claims. Thus, all matter herein set forth should be interpreted as illustrative, and the scope of the disclosure and the appended claims should not be limited to the embodiments described and shown herein.

What is claimed is:

1. An aqueous drilling fluid comprising:
(a) sepiolite;
(b) potassium carbonate; and
(c) water

2. A method for drilling a subterranean well through a subterranean formation which comprises circulating in the well during drilling the aqueous drilling fluid of claim 1.

3. The method of claim 1, wherein the temperature in the well is from 500° F. to 1200° F.

4. The method of claim 3, wherein the well is a geothermal well.

5. The method of claim 2, wherein the pH of the fluid is from about 8.0 to about 12.5.

6. The method of claim 5, wherein the pH of the fluid is from about 9.5 to about 12.0.
